(19) United States
(12) Patent Application Publication
(10) Pub. No.: US 2017/0160414 A1
(43) Pub. Date: Jun. 8, 2017

(54) METHOD AND DEVICE FOR SIMULTANEOUSLY ATTENUATING NOISE AND INTERPOLATING SEISMIC DATA

(71) Applicant: CGG SERVICES SA, Massy Cedex (FR)

(72) Inventor: Raphael STERNFELS, Antony (FR)

(21) Appl. No.: 14/960,877

(22) Filed: Dec. 7, 2015

(51) Int. Cl. G01V 1/36

(52) U.S. Cl. CPC G01V 1/36; G01V 2210/57; G01V 2210/32

(57) ABSTRACT

Seismic survey data is processed to simultaneously attenuate noise and interpolate the data. A frequency slice of one of a plurality of overlapping subvolumes formed from the seismic survey data is selected. A noise reduced, interpolated frequency slice is generated by jointly minimizing a nuclear norm of a trajectory matrix data corresponding to the desired data and an L₁ norm of erratic noise in the selected frequency slice. The noise reduced and interpolated frequency slice is combined with at least one other frequency slice to produce a noise reduced, interpolated frequency subvolume of the surveyed area. The noise reduced, interpolated frequency subvolume is combined with at least one other noise reduced, interpolated frequency subvolume to produce noise reduced, interpolated seismic data of the surveyed area.

### BACKGROUND

Technical Field

Embodiments of the subject matter disclosed herein generally relate to improving seismic data by simultaneously attenuating noise and interpolating seismic data.

Discussion of the Background

Seismic surveys are performed to identify features beneath the earth's surface, such as natural resource deposits. The surveys involve applying one or more waves into the surface and receiving and recording the reflections. The arrival times and amplitudes of the reflections are used to construct a representation of the geological layers on which the waves reflected.

The signals produced using the reflected waves are very noisy and the level of the desired data can be quite low compared to the noise. It is thus required to post-process the signals to improve the desired data and attenuate the noise. Further, although it is common in seismic signal processing to assume the collected data is regularly sampled in space, this is often not the case in practice. Instead the data can have large gaps and irregular sampling requiring interpolation and regularization prior to further processing. Given the large volume of data to be processed the noise attenuation, interpolation, and regularization can be quite costly in terms of computing power and typically requires very large supercomputers for the processing to be completed within a reasonable amount of time. Thus, the processing is typically performed serially so that noise attenuation and interpolation are performed one after the other but not at the same time.

Although serially processing the seismic data reduces the overall processing burden, it also increases the overall time to process the data. Accordingly, it would be desirable to provide devices, systems and methods to simultaneously attenuate noise and regularize/interpolate the data so that the processing can be completed within a shorter amount of time than serial processing when using the same processing hardware.

### SUMMARY

Seismic data captured from a surveyed area is improved by simultaneously reducing erratic and random noise and regularizing/interpolating the seismic data, which involves joint minimization of a nuclear norm of trajectory matrix data corresponding to the desired signal and an L₁ norm of erratic noise component in the seismic data, constrained to the fit to the original, incomplete data.

According to one embodiment, there is a method for enhancing desired data in seismic survey data captured from a surveyed area by simultaneously attenuating noise and interpolating the seismic data. A frequency slice of one of a plurality of overlapping subvolumes formed from the seismic survey data is selected. A noise reduced, interpolated frequency slice is generated by jointly minimizing a nuclear norm of trajectory matrix data corresponding to the desired data and an L₁ norm of erratic noise in the selected frequency slice. The noise reduced and interpolated frequency slice is combined with at least one other frequency slice to produce a noise reduced, interpolated frequency subvolume of the surveyed area. The noise reduced, interpolated frequency subvolume is combined with at least one other noise reduced, interpolated frequency subvolume to produce noise reduced, interpolated seismic data of the surveyed area.

According to another embodiment there is a non-transitory computer-readable medium containing computer-executable code, which when read by a computer causes the computer to perform a method for enhancing desired data in seismic survey data captured from a surveyed area by simultaneously attenuating noise and interpolating the seismic data. A frequency slice of one of a plurality of overlapping subvolumes formed from the seismic survey data is selected. A noise reduced, interpolated frequency slice is generated by jointly minimizing a nuclear norm of trajectory matrix data corresponding to the desired data and an L₁ norm of erratic noise in the selected frequency slice. The noise reduced and interpolated frequency slice is combined with at least one other frequency slice to produce a noise reduced, interpolated frequency subvolume of the surveyed area. The noise reduced, interpolated frequency subvolume is combined with at least one other noise reduced, interpolated frequency subvolume to produce noise reduced, interpolated seismic data of the surveyed area.

According to yet another embodiment there is a computing system for performing a method for enhancing desired data in seismic survey data captured from a surveyed area by simultaneously attenuating noise and interpolating the seismic data. The computing system includes a storage device having a plurality of overlapping subvolumes formed from the seismic survey data and a processor in communication with the storage device. The processor is configured to select a frequency slice of one of the plurality of overlapping subvolumes formed from the seismic survey data, generate a noise reduced, interpolated frequency slice by jointly minimizing a nuclear norm of trajectory matrix data corresponding to the desired data and an L₁ norm of erratic noise in the selected frequency slice, combine the noise reduced and interpolated frequency slice with at least one other frequency slice to produce a noise reduced, interpolated frequency subvolume of the surveyed area, and combine the noise reduced, interpolated frequency subvolume with at least one other noise reduced, interpolated frequency subvolume to produce noise reduced, interpolated seismic data of the surveyed area.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flowchart of embodiments of a method for jointly reducing noise and interpolating seismic data;

FIG. 2 is a schematic representation of a computing system for use in executing the methods of jointly reducing noise and interpolation of seismic data;

FIGS. 3A and 3B are additional flowcharts of embodiments of a method for jointly reducing noise and interpolating seismic data;

FIG. 4A is an original central Common-Offset-Vector (COV) volume of a land dataset;

FIG. 4B is the central COV volume of FIG. 4A after decimation and with erratic noise added in the form of random high-amplitude spikes;

FIG. 4C is the central COV volume of FIG. 4B after undergoing the joint noise reduction and interpolation of the methods of FIGS. 1, 3A, and 3B;

FIG. 4D is the difference between FIGS. 4A and 4C;

FIG. 5A is a stack of COV volumes of a land dataset;

FIG. 5B is the stack of COV volumes of FIG. 5A after decimation and with erratic noise added in the form of random high-amplitude spikes;

FIG. 5C is the stack of COV volumes of FIG. 5B after undergoing the joint noise reduction and interpolation of the methods of FIGS. 1, 3A, and 3B;

FIG. 5D is the difference between FIGS. 5A and 5D;

FIG. 6A is an inline section of a prestack offset class of a marine dataset;

FIG. 6B is the prestack inline section of FIG. 6A after decimation and with erratic noise added;

FIG. 6C is the prestack inline section of FIG. 6B after undergoing the joint noise reduction and interpolation of the methods of FIGS. 1, 3A, and 3B;

FIG. 6D is the difference between FIGS. 6A and 6D;

FIG. 7A is a stacked inline section of a marine dataset;

FIG. 7B is the stacked inline section of FIG. 7A after decimation and with erratic noise added;

FIG. 7C is the stacked inline section of FIG. 7B after undergoing the joint noise reduction and interpolation of the methods of FIGS. 1, 3A, and 3B; and

FIG. 7D is the difference between FIGS. 7A and 7D.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

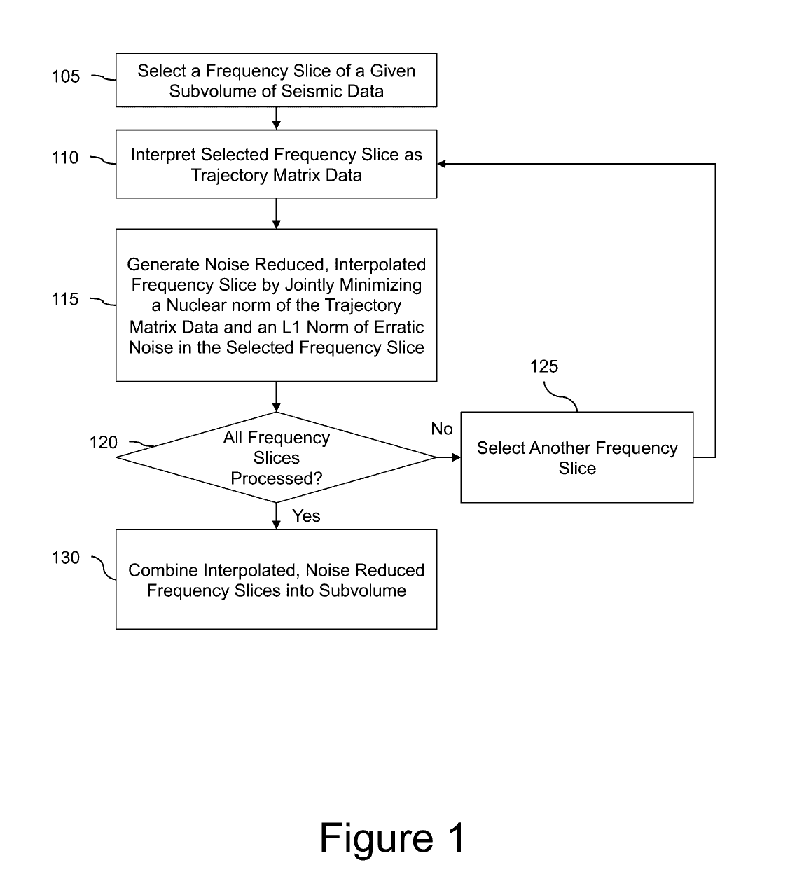

FIG. 1 is a flowchart of embodiments of a method for jointly reducing noise and interpolating seismic data. Initially a frequency slice of a given subvolume of seismic data is selected (step 105). The given subvolume can be one of a number of overlapping subvolumes of seismic data captured from a surveyed area. The selected frequency slice of the given subvolume is then interpreted as trajectory matrix data (step 110). The term trajectory matrix data should be understood as covering both the frequency slice data being converted into an actual matrix or tensor form, as well as treating the frequency slice as being in some type of matrix or tensor form. The latter can at times be much more computationally efficient as it may not require the generation or storage of the matrix.

The selected frequency slice is processed to generate a noise reduced, interpolated frequency slice by jointly minimizing a nuclear norm of the trajectory matrix data corresponding to the desired data and an L1 norm of the erratic noise (step 115). For regularly sampled data this minimization can be represented as follows:

minimize ∥T(S)∥*+λ∥P[E]∥₁

subject to P[D]=S+E+Z,

∥Z∥₂≦δ. (1)

where D is the original frequency slice; S is the noise reduced, interpolated frequency slice; E is the erratic noise component of the frequency slice; Z is additive random noise; δ is an assumed level of random noise; λ is a regularization parameter, which can be selected, for example, through theoretical considerations or experimentation; ∥T(S)∥, is the nuclear norm (i.e., the sum of the singular values) of the trajectory matrix data T(S) for the desired signal S; ∥P[E]∥₁ is the L₁ norm (i.e., the sum of absolute values) of the erratic signal E at locations where original data is available; and P[•] is a sampling operator encoding the available data.

When there are more frequency slices in the seismic data (“No” path out of decision step 120), then another frequency slice is selected (step 125) and the joint minimization is performed on the additional frequency slice (step 115). When all frequency slices of the seismic data have been processed (“Yes” path out of decision step 120) the interpolated, noise reduced frequency slices are combined into an interpolated, noise reduced subvolume (step 130). Interpolated and noise reduced seismic data is then recovered from the frequency subvolume through an inverse frequency-to-time transform such as the Fourier transform. The processed subvolume can then be merged with other subvolumes of the seismic data corresponding to the surveyed area. The joint minimization of the nuclear norm of the trajectory matrix data and an L1 norm of the erratic noise provides a computationally efficient way to simultaneously attenuate noise and interpolate the seismic data.

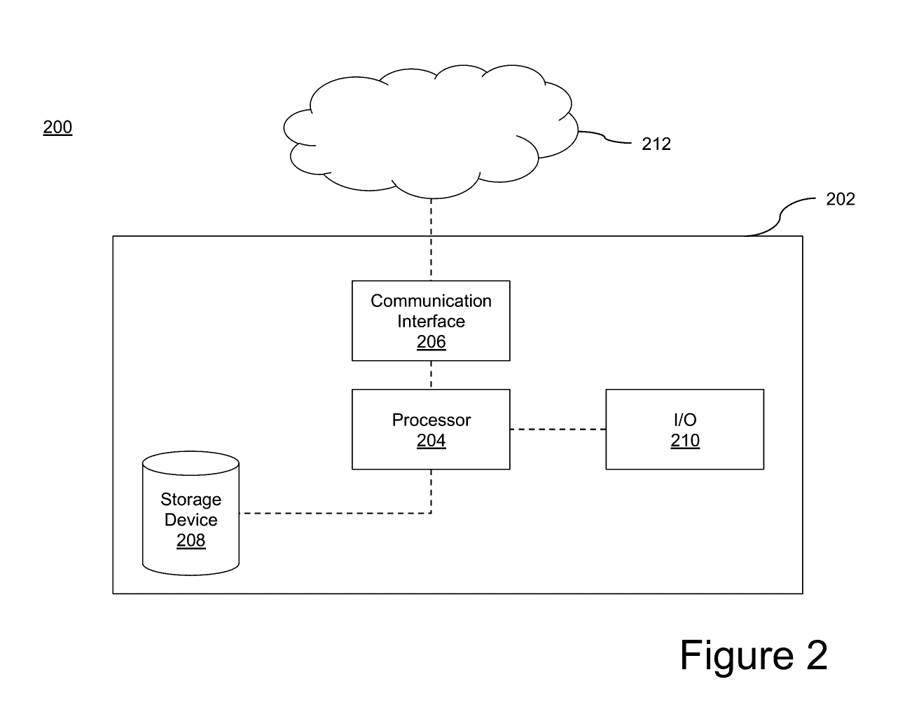

FIG. 2 illustrates a computing system 200 for performing a method for simultaneously attenuating noise and interpolating seismic survey data. In one embodiment, a computing device for performing the processing disclosed herein may be any type of computing device capable of obtaining, processing and communicating seismic traces from one or more seismic datasets associated with seismic surveys. The computing system 200 includes a computer or server 202 having one or more processors 204 in communication with a communication interface 206, one or more input/output devices 210, and at least one non-transitory storage device 208. Communication interface 206 couples computer or server 202 to network 212, which can be any type of network. The processor 202 is configured to perform the methods described below using computer instructions stored on a non-transitory computer readable-medium, which can be part of storage device 212.

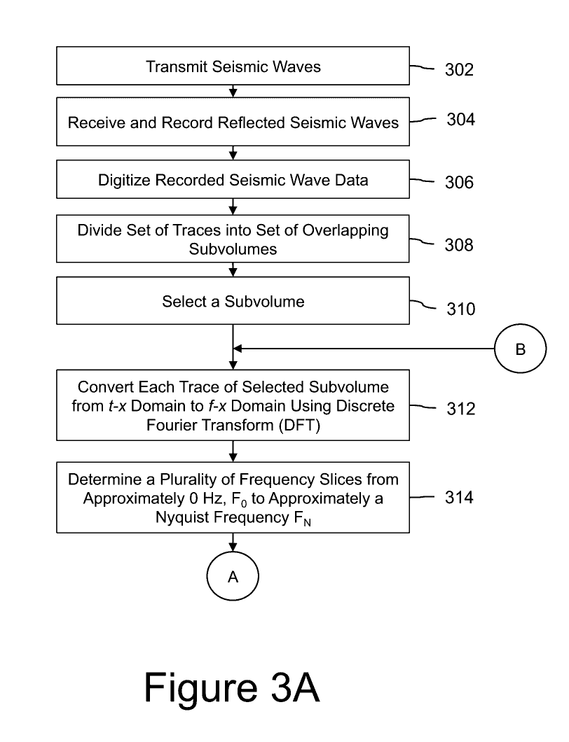

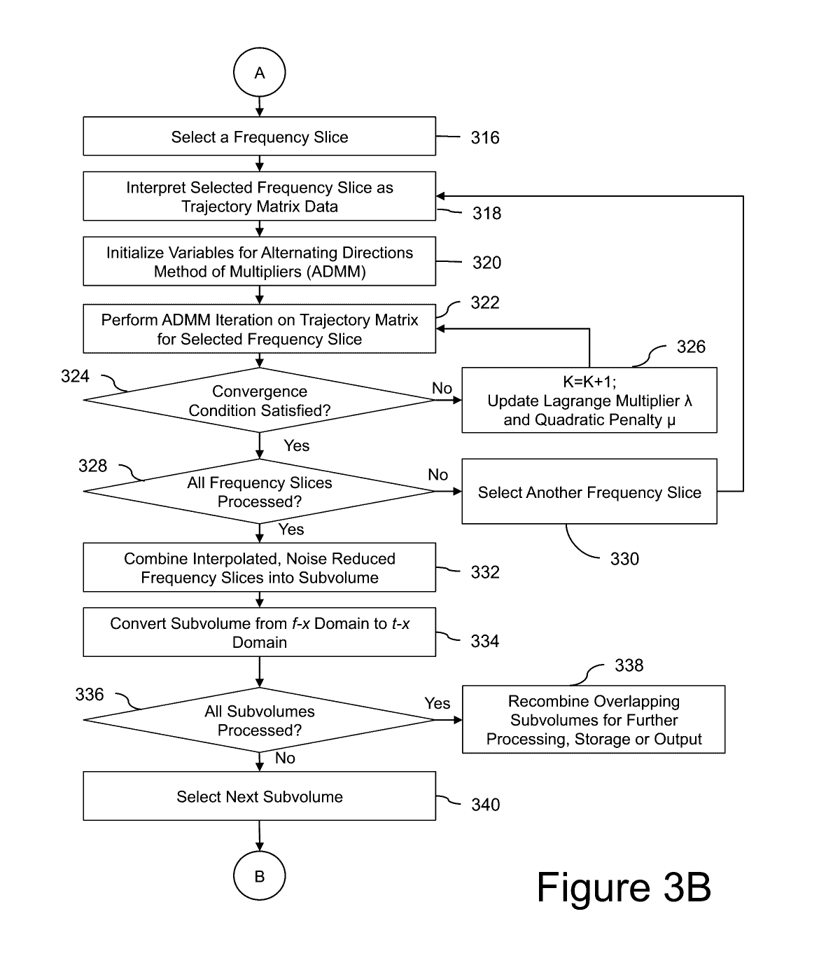

FIGS. 3A and 3B are additional flowcharts of embodiments of a method for jointly reducing noise and interpolating seismic data, which will be described in connection with the computing system 200 of FIG. 2. Initially, seismic equipment transmits seismic waves into a surveyed area and receives and records the reflections (step 302 and 304). The seismic equipment can be land or marine seismic equipment. The recorded seismic data is then provided to computing system 200 for further processing.

The seismic data can be provided to processor 204 after being previously stored in storage device 208 and/or can be received from network 212 via communication interface 206. This can be performed under the control of I/O device 210, such as a keyboard, mouse, trackpad, etc. Network 212 can be any type of wired and/or wireless network, and accordingly communication interface 206 will be configured to communicate using the appropriate protocols for the particular network.

Processor 204 digitizes the seismic data into a set of traces (step 306), divides the set of traces into a set of overlapping subvolumes (step 308), selects one of the overlapping subvolumes (step 310), and converts each trace for the selected subvolume from the time-distance domain (i.e., the t-x domain) into the frequency-distance domain (i.e., the f-x domain) using, for example, a Discrete Fourier Transform (DFT) (step 312). Processor 304 then selects one of the traces or a stack of traces and determines a plurality of frequency slices from approximately 0 Hz, F₀ to approximately a Nyquist frequency F_{N} (step 314). One of the frequency slices is selected (step 316) and the signal model of the desired data to be recovered is interpreted as a trajectory matrix data (step 318), which as discussed above does not necessarily require generation or storage of a trajectory matrix and includes interpreting the data as-is in tensor form. An example of a trajectory matrix H for a window of five traces and a frequency slice S=(S₁, . . . , S₅) is:

$$H ( S ) = ( \begin{matrix}{S}_{1} & {S}_{2} & {S}_{3} \\ {S}_{2} & {S}_{3} & {S}_{4} \\ {S}_{3} & {S}_{4} & {S}_{5}\end{matrix} ) \qquad ( 2 )$$

From the predictability assumption it should be appreciated that for a single dipping event the columns of the trajectory matrix are scaled versions of each other, and accordingly H(S) has a rank 1. Accordingly, a noiseless dataset that is the sum of k plane waves results in a trajectory matrix having at most rank k. This observation is used in conventional Cadzow/Singular Spectrum Analysis (SSA) filtering to attenuate random noise in the recorded data D by reducing the rank of the trajectory matrix T(D) via singular value decomposition (SVD), discarding smaller singular values. The resulting matrix is then averaged along its antidiagonals to yield the denoised signal S. If the recorded data D is both incomplete and corrupted by erratic noise applying the Cadzow/SSA procedure directly to the recorded data D would provide incorrect results because SVD is very sensitive to outliers and missing data. Accordingly, as will be described in more detail below, embodiments account for both a sampling operator encoding available information and an erratic noise contribution to the data.

The trajectory matrix H(S) given as an example in Equation 2 has a Hankel structure and can also be represented by the following equivalent Toeplitz matrix:

$$T ( S ) = ( \begin{matrix}{S}_{3} & {S}_{2} & {S}_{1} \\ {S}_{4} & {S}_{3} & {S}_{2} \\ {S}_{5} & {S}_{4} & {S}_{3}\end{matrix} ) \qquad ( 3 )$$

For a window of N traces the matrix T(S) is a square dimension (N+1)/2 if N is odd and rectangular of size N/2×N/2+1 if N is even. Although the disclosure herein relates to a single spatial dimension it can be extended to several spatial dimensions, which amounts, in the example discussed here, to building block Toeplitz matrices with Toeplitz blocks (BTTB matrices) of an order corresponding to the additional spatial dimensions. The matrix for two spatial dimensions will be:

$$T ( S ) = ( \begin{matrix}{T}_{3} & {T}_{2} & {T}_{1} \\ {T}_{4} & {T}_{3} & {T}_{2} \\ {T}_{5} & {T}_{4} & {T}_{3}\end{matrix} ) \qquad ( 4 )$$

where each Tᵢ is a Toeplitz matrix. For additional spatial dimensions the Tᵢ matrices would be recursively replaced by BTTB matrices. For more information regarding how to build BTTB matrices the interested reader should refer to the article “Simultaneous Seismic Data Denoising and Reconstruction Via Multichannel Singular Spectrum Analysis” by Oropeza and Sacchi. (Geophysics, 76, pp. 25-32, 2011), the entire disclosure of which is expressly incorporated by reference.

The processor 204 then jointly minimizes a nuclear norm of the trajectory matrix data corresponding to the desired data and an L₁ norm of the erratic noise in the selected frequency slice, constrained by the fit to the original data, which is an optimization problem, that can be solved, for example, using a primal-dual proximal splitting algorithm such as an Alternating Directions Method of Multipliers (ADMM) algorithm (steps 320-326). It should be appreciated that the exposition here follows a convex formulation of the main problem at hand, joint rank minimization of the trajectory matrix corresponding to the desired data and sparsity maximization of the erratic noise component, constrained by the fit to the original data.

In order to solve the convex optimization problem described above in connection with the formulation in equation (1), using for instance the ADMM algorithm, the following augmented Lagrangian is used as a starting point:

$$L ( S , E , Z , M ) = {‖ T ( S ) ‖}_{*} + λ {‖ P [ E ] ‖}_{1} + 〈 M , P [ D ] - S - E - Z 〉 + \frac{1}{2 μ} {‖ P [ D ] - S - E - Z ‖}_{2}^{2} + {ι}_{\{ {‖ Z ‖}_{2} ≦ δ \}} ( Z ) \qquad ( 5 )$$

where M is the dual variable of Lagrange multiplier, μ is the parameter associated with the added quadratic penalty, and ι_{C}(•) is the characteristic function of the set C: ι_{C}(c)=0 if c∈C and +∞ if c∉C. The added quadratic penalty term of equation (5) makes the cost function and solution procedure more robust. Using the Lagrangian of equation (5) the k-th iteration of the method of multipliers is:

$$\begin{matrix}( {S}^{k + 1} , {E}^{k + 1} , {Z}^{k + 1} ) = {arg min}_{S , E , Z} L ( S , E , Z , {M}^{k} ) , & ( 6 ) \\ {m}^{k + 1} = {M}^{k} + \frac{1}{μ} ( P [ D ] - {S}^{k + 1} - {E}^{k + 1} - {Z}^{k + 1} ) . & ( 7 )\end{matrix}$$

Although using a method of multipliers would make the first subproblem difficult to efficiently solve due to the non-separability of the objective function, which is due to the additional quadratic penalty term, using ADMM addresses this difficulty by splitting and updating the variables one at a time before updating the multiplier. The k-th ADMM iteration will be:

$$\begin{matrix}{Z}^{k + 1} = {arg min }_{Z} L ( {S}^{k} , {E}^{k} , Z , {M}^{k} ) & ( 8 ) \\ {E}^{k + 1} = {arg min}_{E} L ( {S}^{k} , E , {Z}^{k + 1} , {M}^{k} ) , & ( 9 ) \\ {S}^{k + 1} = {arg min }_{S} L ( S , {E}^{k + 1} , {Z}^{k + 1} , {M}^{k} ) , & ( 10 ) \\ {M}^{k + 1} = {M}^{k} + \frac{1}{μ} ( P [ D ] - {S}^{k + 1} - {E}^{k + 1} - {Z}^{k + 1} ) & ( 11 )\end{matrix}$$

It should be recognized that there is only currently strict proof of convergence for ADMM when the number of updated variables is two and there is no strict proof of convergence when the number of updated variables is three or higher as in this implementation of ADMM. Nevertheless, satisfactory behavior was observed using ADMM in this manner with seismic data, as will be detailed below. Merging the relevant multiplier term with the quadratic penalty term results in:

$$\begin{matrix}{Z}^{k + 1} = arg {m}_{Z} in {ι}_{\{ {‖ Z ‖}_{2} ≦ δ \}} ( Z ) + \frac{1}{2 μ} {‖ P [ D ] - {S}^{k} - {E}^{k} - Z + μ {M}^{k} ‖}_{2}^{2} , & ( 12 ) \\ {E}^{k + 1} = {arg min}_{E} {‖ P [ E ] ‖}_{1} + \frac{1}{2 μλ} {‖ P [ D ] - {S}^{k} - E - {Z}^{k + 1} + μ {M}^{k} ‖}_{2}^{2} , & ( 13 ) \\ {S}^{k + 1} = {arg min}_{S} {‖ T [ S ] ‖}_{*} + \frac{1}{2 μ} {‖ P [ D ] - S - {E}^{k + 1} - {Z}^{k + 1} + μ {M}^{k} ‖}_{2}^{2} , & ( 14 ) \\ {M}^{k + 1} = {M}^{k} + \frac{1}{μ} ( P [ D ] - {S}^{k + 1} - {E}^{k + 1} - {Z}^{k + 1} ) . & ( 15 )\end{matrix}$$

The subproblems for Z, E, and S involve proximal operators and solving one subproblems is equivalent to evaluating the proximal operator of a certain function. The proximal operation of a function f is defined by:

$${prox}_{f} ( v ) = {arg min }_{x} f ( x ) + \frac{1}{2} {‖ x - v ‖}_{2}^{2} \qquad ( 16 )$$

A noteworthy property of proximal operators is that a minimizer of a function is a fixed point of its proximal operator. Accordingly, the subproblems for Z, E, and S can be rewritten as follows:

Z^{k+1}=prox_{μι{∥•∥}_{₂}_{≦δ}}(P[D]−S^{k}−E^{k}+μM^{k}), (17)

E^{k+1}=prox_{μλ∥P[•]∥}_{₁}(P[D]−S^{k}−Z^{k+1}+μM^{k}), (18)

S^{k+1}=prox_{μ∥T(•)∥*}(P[D]−E^{k+1}−Z^{k+1}+μM^{k}), (19)

Regarding the characteristic function ι_{{∥•∥}_{₂}_{≦δ}} of a Euclidean norm ball, the proximal operator reduces to the projection operator:

$${{prox}_{{ι}_{\{ {‖ \cdot ‖}_{2} ≦ δ \}}} ( v ) = {\prod }_{\{ {‖ \cdot ‖}_{2} ≦ δ \}} ( v ) = {arg min}_{{‖ x ‖}_{2} ≦ δ} ‖ x - v ] ‖}_{2} {=}^{ } \frac{min ( {‖ v ‖}_{2} , δ )}{{‖ v ‖}_{2}} v . \qquad ( 20 )$$

Soft thresholding is the proximal operator associated to the entrywise L₁ norm:

$${( {prox}_{α {‖ \cdot ‖}_{1}} ( A ) )}_{i} = \frac{{A}_{i}}{\vert {A}_{i} \vert} max ( \vert {A}_{i} \vert - α , 0 ) . \qquad ( 21 )$$

Singular value thresholding is the proximal operator associated to the nuclear norm:

$${prox}_{β {‖ \cdot ‖}_{*}} ( B ) = {\sum }_{i = 1}^{n} max ( {σ}_{i} - β , 0 ) {u}_{i} {v}_{i}^{T} , \qquad ( 22 )$$

where B=Σᵢ₌₁ⁿσᵢuᵢvᵢ^{T} is the SVD of B. Using the properties of proximal operators in connection with the previous formulas results in the ADMM iterations being written as:

Initialize variables: Z⁰=0, E⁰=0, S⁰=0, and M⁰=D/∥D∥₂ (step 320) where Z is the additive random noise data; E is the erratic noise data; S is the desired signal data; D is the frequency slice; M is the dual variable or Lagrange multiplier; and ∥D∥₂ is the L₂ norm of the frequency slice. Each iteration (step 322) of the ADMM algorithm which can be chosen to solve the problem described above involves:

$$\begin{matrix}{Z}^{k + 1} = \frac{min ( {‖ V ‖}_{2} , δ )}{{‖ V ‖}_{2}} V , with V = P [ D ] - {S}^{k} - {E}^{k} + μ {M}^{k} ; & ( 23 ) \\ {( {E}^{k + 1} )}_{i} = \{ \begin{matrix}\frac{{A}_{i}}{[ {A}_{i} ]} max ( \vert {A}_{i} \vert - μλ , 0 ) if i {ε}^{″} , \\ {A}_{i} otherwise , with A = P [ D ] - {S}^{k} - {E}^{k} + μ {M}^{k} ;\end{matrix} & ( 24 ) \\ {S}^{k + 1} = 𝒯 [ {\sum }_{r} max ( {σ}_{r} - μ , ) ) {u}_{r} {v}_{r}^{T} ] & ( 25 ) \\ where & \\ T ( P [ D ] - {E}^{k + 1} - {Z}^{k + 1} + μ {M}^{k} = {\sum }_{r} {σ}_{r} {u}_{r} {v}_{r}^{T} is an SVD \\ & \\ {M}^{k + 1} = {M}^{k} + \frac{1}{μ} ( P [ D ] - {S}^{k + 1} - {E}^{k + 1} - {Z}^{k + 1} ) & ( 26 )\end{matrix}$$

The updates of Z, E, S and M can be performed in any order. The convergence condition can be ∥S^{k+1}−S^{k}∥₂+∥E^{k+1}−E^{k}∥₂≦∈ for a user-defined ∈ (selected to satisfy a given convergence tolerance, possibly up to machine precision), or when a predefined number of iterations are performed (selected as a function of allocated computational resources to solve the problem.

Recall that for the trajectory matrix form described here, T(•) is the operator transforming a frequency slice into a Toeplitz (or BTTB) matrix and [symbol] [•] is its adjoint operator, averaing the (block) diagonals of a Teoplitz (BTTB) matrix.

ADMM iterations (step 322) are performed on the selected frequency slice until a convergence condition is satisfied (step 324). When the convergence condition is not satisfied (“No” path out of decision step 324), then K is incremented by one and the Lagrange multiplier λ and quadratic penalty μ are updated (step 326) for the next iteration (step 322).

When the processor 204 determines that the convergence conditions are satisfied (“Yes” path out of decision step 324), then the processor 204 determines whether all frequency slices have been processed (step 328). When there are remaining frequency slices (“No” path out of decision step 328) another frequency slice is selected (step 330) and processed (steps 318-326). When all frequency slices have been processed (“Yes” path out of decision step 328), the processor 204 combines the interpolated, noise reduced frequency slices into a subvolume consisting of several traces (step 332) and converts the subvolume back into the time-distance domain t-x (step 334).

Processor 204 then determines whether all of the subvolumes have been processed (step 336). If not (“No” path out of decision step 336), another subvolume is selected (step 340) and the processing of steps 312-334 is repeated for the additional subvolume. Once all overlapping subvolumes have been processed (“Yes” path out of decision step 336), the overlapping subvolumes are recombined for further processing, storage in storage device 204, or output via I/O 210 or communication interface 206 (step 338).

The discussion above assumes that the seismic data is regularly sampled. The techniques discussed above, however, can also be used with irregularly sampled data, such as data with traces that are not bin-centered, data with duplicate bins, and data with empty bins. To address the irregular sampling a non-uniform discrete Fourier transform, possibly computed via a non-uniform fast-Fourier transform (NUFFT), also referred to as an unequally spaced FFT (USFFT)), is employed in the optimization algorithm. The irregular sampling also requires changes to the minimization of terms and the application of the ADMM. For irregularly sampled data the minimization would be:

minimize ∥T(S_{reg})∥*+λ∥E∥₁ (27)

subject to D= [symbol] S_{reg}+E+Z,

∥Z∥₂≦δ.

where [symbol] is the regular to irregular sampling operator (which can be computed, for example, by a composition of a uniform “forward” discrete Fourier transform followed by a non-uniform “backward” discrete Fourier transform), S_{reg} is the noise reduced, interpolated frequency slice that is regularized on a regular spatial domain grid; D is the input frequency slice; E is the erratic noise data; Z is the additive random noise data; δ is an assumed level of random noise; λ is a regularization parameter; ∥T(S_{reg})∥* is the nuclear norm (i.e., the sum of the singular values) of the trajectory matrix data T(S_{reg}) for the desired regularized signal S_{reg}; and ∥E∥₁ is the L₁ norm (i.e., the sum of absolute values) of the erratic signal component E.

The variable splitting of equations (27) results in the following Lagrangian:

$$L ( S , E , Z , M ) = {‖ T ( {S}_{reg} ) ‖}_{*} + λ {‖ E ‖}_{1} + 〈 M , D - {S}_{reg} - E - Z 〉 + \frac{1}{2 μ} {‖ D - {S}_{reg} - E - Z ‖}_{2}^{2} + {ι}_{\{ {‖ Z ‖}_{2} ≦ δ \}} ( Z ) . \qquad ( 29 )$$

The convex minimization of equation (27) is solved using a proximal splitting technique, which is a generalization of the ADMM technique described above. The generalization is needed because of the added constraint due to the irregular sampling. Each ADMM iteration for the irregularly sampled data involves, where updates can be performed in any order:

$$\begin{matrix} {Z}^{k + 1} = {\prod }_{\{ {‖ Z ‖}_{2} ≦ δ \}} ( D - {S}_{reg}^{k} - {E}^{k} + μ {M}^{k} ) , & ( 30 ) \\ {E}^{k + 1} = {prox}_{μ λ {‖ \cdot ‖}_{1}} ( D ( D - {S}_{reg}^{h} - {Z}^{k + 1} + μ {M}^{k} ) , & ( 31 ) \\ {S}_{reg}^{k + 1} = arg {min}_{{S}_{reg}} {‖ T ( {S}_{reg} ) ‖}_{*} + \frac{1}{2 μ} {‖ D - {S}_{reg} - {E}^{k + 1} - {Z}^{k + 1} + μ {M}^{k} ‖}_{2}^{2} , & ( 32 ) \\ {M}^{k + 1} = {M}^{k} + \frac{1}{μ} ( D - {S}_{reg}^{k + 1} - {E}^{k + 1} - {Z}^{k + 1} ) . & ( 33 )\end{matrix}$$

where Π_{{∥Z∥}_{₂}_{≦δ}} corresponds to the projection onto the 2-norm ball of radius δ; and prox_{μλ∥•∥}_{₁} represents the proximal operator associated with the 1-norm, i.e., the soft-thresholding.

In addition to the use of the regular to irregular sampling operator [symbol] , the updates of Z, E, and M are performed in the irregular domain, which is why the sampling operator P[•] disappears in the case of the irregularly sampled data. The main difference between the ADMM iterations for the regularly and irregularly sampled data is in the update of S_{reg}, which does not correspond to a proximal operator because of the presence of the irregular sampling operator [symbol] , which excludes direct application of the singular value thresholding operator. To avoid a costly inversion of the regular to irregular sampling operator [symbol] , the S_{reg} update can be solved as follows using a forward-backward splitting technique:

S_{reg}^{k+1=} [symbol] ^{[prox}_{ημ∥•∥*}T(S_{reg}^{k}−η [symbol] ( [symbol] S_{reg}^{k}−(D−E^{k+1}−Z^{k+1}+μM^{k})))], (34)

where η is a step parameter satisfying 0<η<2/∥ [symbol] [symbol] ∥ to ensure convergence. The S_{reg} update corresponds to a “forward” step corresponding to evaluating the gradient of the second term in equation (32), followed by a “backward” step involving the proximal operator of the nuclear norm, i.e., the singular value thresholding operator.

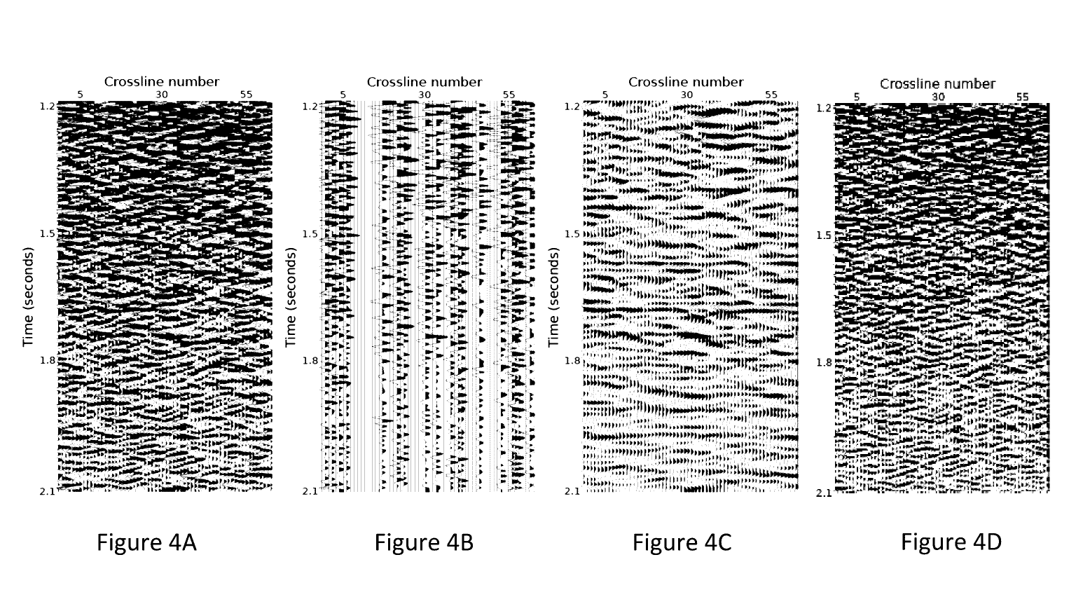

The application of the simultaneous noise reduction and interpolation will now be described in connection with the data illustrated in FIGS. 4A-10D.

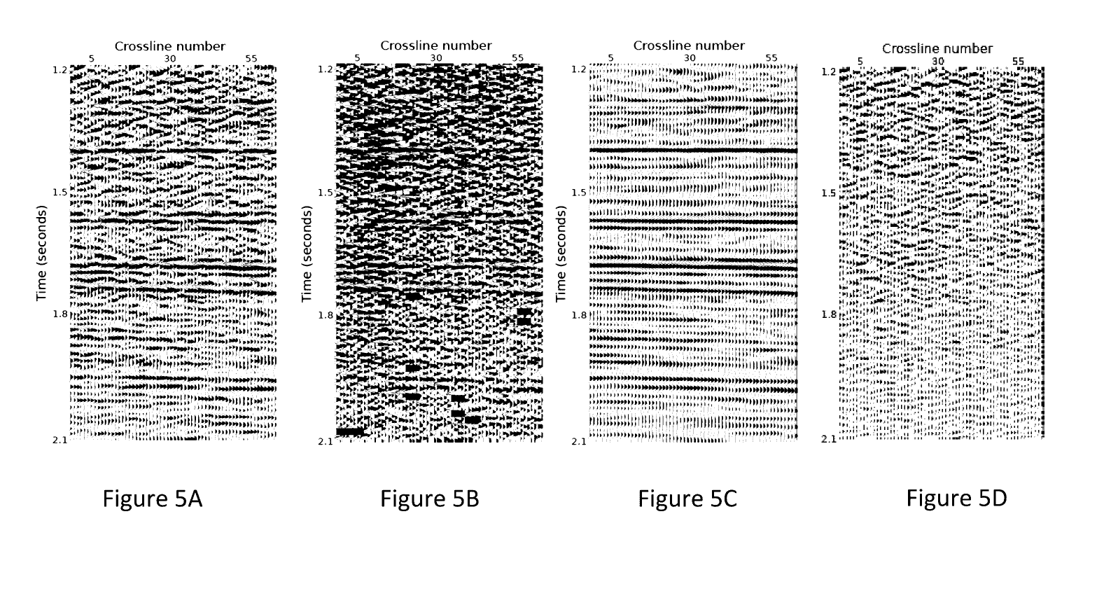

FIGS. 4A-4D and 5A-5D are based on a land dataset arranged in thirty-six Common-Offset-Vector (COV) volumes, which have been corrected for normal moveout (NMO) and which have inline and crossline increments of fifteen meters. The discussion of the FIGS. 4A-4D and 5A-5D below involves the use of four spatial dimensions: inline, crossline, and both components of the offset vector. The processing window extent was 600 milliseconds in the temporal direction, 30 traces in the inline and crossline directions, and 4 traces in both binned offset vector component directions.

FIGS. 4A-4D involve the central COV volume of this land dataset. FIG. 4A is the original COV volume, which is quite noisy and thus has a low signal-to-noise ratio. The noise present in FIG. 4A is generally random noise. In order to demonstrate the effectiveness of the methods of FIGS. 1, 3A, and 3B the original COV volume of FIG. 4A was decimated so that 75% of the traces were removed and 25% remained, and erratic noise spikes were added. The joint noise reduction and interpolation of the methods of FIGS. 1, 3A, and 3B was applied to the COV volume of FIG. 4B to result in the noise reduced, interpolated volume of FIG. 4C. As will be appreciated, the interpolation addressed the decimation and the noise reduction attenuated the added erratic noise. Specifically, the noise reduced and interpolated central COV volume in FIG. 4C clearly shows horizontal events that are not readily discernable in the original central COV volume of FIG. 4A. FIG. 4D, which is the difference between the original COV volume of FIG. 4A and the noise reduced, interpolated COV volume of FIG. 4C, illustrates the noise removed from the original COV volume of FIG. 4A.

FIG. 5A is a stack of COV volumes of the land dataset used in FIGS. 4A-4D. Again, to demonstrate the effectiveness of the methods of FIGS. 1, 3A, and 3B the original COV volume of FIG. 5A was decimated so that 75% of the prestack traces were removed and 25% remained, and erratic noise spikes were added. The joint noise reduction and interpolation of the methods of FIGS. 1, 3A, and 3B was applied to the stack of COV volumes of FIG. 5B to result in the noise reduced, interpolated volume of FIG. 5C, which shows that the interpolation addressed the decimation and the noise reduction attenuated the added erratic noise. By comparing FIGS. 5A and 5C it can be seen that the horizontal events that are visible in the original stack of COV volumes in FIG. 5A are much more pronounced in the noise reduced and interpolated stack of COV volumes in FIG. 5C, which is due to the reduction of the noise. Thus, it will be appreciated that the methods of FIGS. 1, 3A, and 3B provide effective noise attenuation and reconstruction while still preserving the character of the data, with minimal signal leakage. FIG. 5D, which is the difference between the original stack of COV volumes of FIG. 5A and the noise reduced, interpolated stack of COV volumes of FIG. 5C, illustrates the noise removed from the stack of original COV volumes of FIG. 5A.

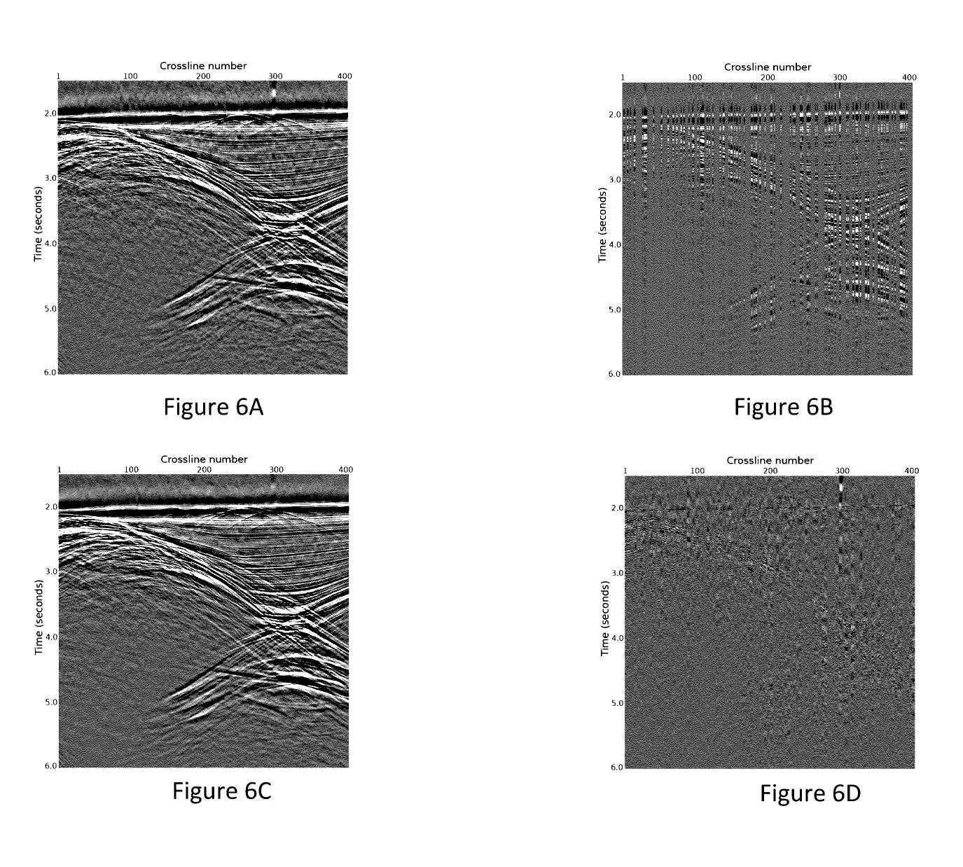

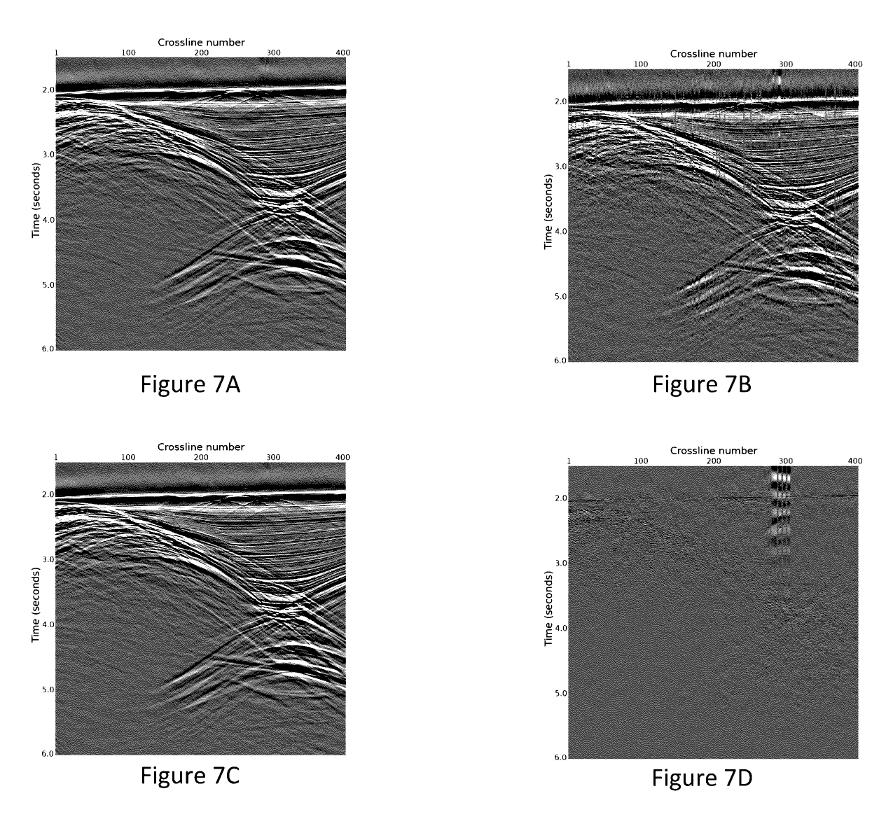

FIGS. 6A-6D and 7A-7D illustrate the application of the methods of FIGS. 1, 3A, and 3B to a marine dataset, which uses offset classes with NMO correction. The inline and crossline increments are 25 and 12.5 meters, respectively. Three spatial dimensions were used: inline number, crossline number, and offset class number. The processing window temporal size was 500 milliseconds and the spatial window extent was 20 traces in both inline and crossline directions and four traces in the offset class direction.

FIG. 6A is an inline section of a prestack offset class of marine dataset. This dataset includes a very prominent erratic noise spike directly under the crossline number 300. The inline section of FIG. 6A was decimated so that 75% of the traces were removed and 25% remained, and erratic noise spikes were added to result in FIG. 6B. The joint noise reduction and interpolation of the methods of FIGS. 1, 3A, and 3B was applied to the inline section of FIG. 6B to result in the noise reduced, interpolated volume of FIG. 6C. The interpolation addressed the decimation and the noise reduction attenuated the added erratic noise. FIG. 6D, which is the difference between the original inline section of FIG. 6A and the noise reduced, interpolated inline section of FIG. 6C, illustrates the noise removed from the original inline section of FIG. 6A. As illustrated in FIG. 6D, the erratic noise spike directly under the crossline number 300 was removed by the methods of FIGS. 1, 3A, and 3B.

FIG. 7A is a stacked inline section using the same marine dataset as in FIG. 6A. Similar to the inline prestack section illustrated in FIG. 6A, the stacked inline section of FIG. 7A includes erratic noise under the crossline number 300. In FIG. 7A, the erratic noise is represented by a number of spikes, although they are less prominent than the single spike of FIG. 6A.

The inline section of FIG. 7A was decimated so that 75% of the traces were removed and 25% remained, and erratic noise spikes were added to result in FIG. 7B. In addition to the erratic noise spikes in FIG. 7A, FIG. 7B illustrates a prominent erratic noise spike to the left of crossline number 300. The joint noise reduction and interpolation of the methods of FIGS. 1, 3A, and 3B was applied to the inline section of FIG. 7B to result in the noise reduced, interpolated volume of FIG. 7C. The interpolation addressed the decimation and the noise reduction attenuated the added erratic noise. FIG. 7D, which is the difference between the original inline section of FIG. 7A and the noise reduced, interpolated inline section of FIG. 7C, illustrates the noise removed from the original inline section of FIG. 7A. As illustrated in FIG. 7D, the erratic noise spikes in the area of crossline number 300, including the spikes in the original stack of FIG. 7A and the noise added stack of FIG. 7B, were removed by the methods of FIGS. 1, 3A, and 3B.

Although the discussion above in connection with FIGS. 4A-7D focused on the use of the methods of FIGS. 1, 3A, and 3B in connection with four-dimensional (4D, i.e. three spatial dimensions plus time/frequency) and five-dimensional (5D, i.e. four spatial dimensions plus time/frequency) datasets, these methods can also be used with two and three-dimensional (2D, 3D) datasets.

Thus, it will be appreciated that the disclosed simultaneous noise attenuation and interpolation techniques find wide applicability to seismic survey data. These techniques can be used to improve land, marine, ocean-bottom survey data for instance, as well as multi-dimensional seismic data. Further, these techniques can be used with both regularly and irregularly sampled seismic data.

Methods and systems in accordance with exemplary embodiments can be hardware embodiments, software embodiments or a combination of hardware and software embodiments. In one embodiment, the methods described herein are implemented as software. Suitable software embodiments include, but are not limited to, firmware, resident software and microcode. In addition, exemplary methods and systems can take the form of a computer program product accessible from a computer-usable or computer-readable medium providing program code for use by or in connection with a computer, logical processing unit or any instruction execution system. In one embodiment, a machine-readable or computer-readable medium contains a machine-executable or computer-executable code that when read by a machine or computer causes the machine or computer to perform a method for imaging a near subsurface in accordance with exemplary embodiments and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages.

As used herein, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums and include non-transitory computer-readable mediums. Suitable computer-readable mediums include, but are not limited to, a semiconductor or solid-state memory, magnetic tape, a removable computer diskette, a random access memory (RAM), a read-only memory (ROM), a rigid magnetic disk and an optical disk. Suitable optical disks include, but are not limited to, a compact disk-read only memory (CD-ROM), a compact disk-read/write (CD-R/W) and DVD.

The disclosed exemplary embodiments provide systems and methods for simultaneously attenuating noise and interpolation. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for enhancing desired data in seismic survey data captured from a surveyed area by simultaneously attenuating noise and interpolating the seismic data, the method comprising:
selecting a frequency slice of one of a plurality of overlapping subvolumes formed from the seismic survey data (105, 310, 316);
generating a noise reduced, interpolated frequency slice by jointly minimizing a nuclear norm of trajectory matrix data corresponding to the desired data and an L₁ norm of erratic noise in the selected frequency slice (115, 320-326);
combining the noise reduced and interpolated frequency slice with at least one other frequency slice to produce a noise reduced, interpolated frequency subvolume of the surveyed area (130, 332); and
combining the noise reduced, interpolated frequency subvolume with at least one other noise reduced, interpolated frequency subvolume to produce noise reduced, interpolated seismic data of the surveyed area (338).

2. The method of claim 1, wherein the noise reduced, interpolated frequency slice is generated by iteratively processing the selected frequency slice.

3. The method of claim 2, wherein the iterative processing involves applying alternating directions method of multipliers (ADMM) to the selected frequency slice.

4. The method of claim 1, wherein the selected frequency slice is noisy and incomplete spatially regularly sampled data, and the joint minimization recovers a low-rank signal model of the desired data and a sparse erratic noise model from the noisy and incomplete spatially regularly sampled data.

5. The method of claim 4, wherein the joint minimization is
minimize ∥T(S)∥*+λ∥P[E]∥₁
subject to P[D]=S+E+Z,
∥Z∥₂≦δ.
where D is the selected frequency slice; S is noise reduced, interpolated frequency slice; E is the erratic noise data; Z is the additive random noise data; δ is an assumed level of random noise; λ is a regularization parameter; ∥T(S)∥* is the nuclear norm of the trajectory matrix data T(S) for the noise reduced, interpolated frequency slice S; ∥P[E]∥₁ is the L₁ norm; and P[•] is a sampling operator.

6. The method of claim 1, wherein the selected frequency slice is noisy and incomplete spatially irregularly sampled data, and the joint minimization recovers a low-rank signal model of the desired data and a sparse erratic noise model from the noisy and incomplete spatially irregularly sampled data.

7. The method of claim 6, wherein the joint minimization is
minimize ∥T(S_{reg})∥*+λ∥E∥₁
subject to D= [symbol] S_{reg}+E+Z,
∥Z∥₂≦δ.
where [symbol] is a regular to irregular sampling operator, S_{reg} is the noise reduced, interpolated frequency slice regularized on a spatial domain grid [symbol] ; D is the selected frequency slice; E is the erratic noise; Z is additive random noise; δ is an assumed level of random noise; λ is a regularization parameter; ∥T(S_{reg})∥* is the nuclear norm of the trajectory matrix data T(S_{reg}); and ∥E∥₁ is the L₁ norm of the erratic noise.

8. The method of claim 1, wherein the generation of the noise reduced, interpolated frequency slice involves attenuation of both random noise and the erratic noise.

9. A non-transitory computer-readable medium containing computer-executable code, which when read by a computer causes the computer to perform a method for enhancing desired data in seismic survey data captured from a surveyed area by simultaneously attenuating noise and interpolating the seismic data, the method comprising:
selecting a frequency slice of one of a plurality of overlapping subvolumes formed from the seismic survey data (105, 310, 316);
generating a noise reduced, interpolated frequency slice by jointly minimizing a nuclear norm of trajectory matrix data corresponding to the desired data and an L₁ norm of erratic noise in the selected frequency slice (115, 320-326);
combining the noise reduced and interpolated frequency slice with at least one other frequency slice to produce a noise reduced, interpolated frequency subvolume of the surveyed area (130, 332); and
combining the noise reduced, interpolated frequency subvolume with at least one other noise reduced, interpolated frequency subvolume to produce noise reduced, interpolated seismic data of the surveyed area (338).

10. The non-transitory computer-readable medium of claim 9, wherein the noise reduced, interpolated frequency slice is generated by iteratively processing the selected frequency slice.

11. The non-transitory computer-readable medium of claim 10, wherein the iterative processing involves applying an alternating directions method of multipliers (ADMM) algorithm to the selected frequency slice.

12. The non-transitory computer-readable medium of claim 9, wherein the selected frequency slice is noisy and incomplete spatially regularly sampled data, and the joint minimization recovers a low-rank signal model of the desired data and a sparse erratic noise model from the noisy and incomplete spatially regularly sampled data.

13. The non-transitory computer-readable medium of claim 12, wherein the joint minimization is
minimize ∥T(S)∥*+λ∥P[E]∥₁
subject to P[D]=S+E+Z,
∥Z∥₂≦δ.
where D is the selected frequency slice; S is noise reduced, interpolated frequency slice; E is the erratic noise data; Z is the additive random noise data; δ is an assumed level of random noise; λ is a regularization parameter; ∥T(S)∥* is the nuclear norm of the trajectory matrix data T(S) for the noise reduced, interpolated frequency slice S; ∥P[E]∥₁ is the L₁ norm; and P[•] is a sampling operator.

14. The non-transitory computer-readable medium of claim 9, wherein the selected frequency slice is noisy and incomplete spatially irregularly sampled data, and the joint minimization recovers a low-rank signal model of the desired data and a sparse erratic noise model from the noisy and incomplete spatially irregularly sampled data.

15. The non-transitory computer-readable medium of claim 14, wherein the joint minimization is
minimize ∥T(S_{reg})∥*+λ∥E∥₁
subject to D= [symbol] S_{reg}+E+Z,
∥Z∥₂≦δ.
where [symbol] is a regular to irregular sampling operator, S_{reg} is the noise reduced, interpolated frequency slice regularized on spatial domain grid [symbol] ; D is the selected frequency slice; E is the erratic noise; Z is additive random noise; δ is an assumed level of random noise; λ is a regularization parameter; ∥T(S_{reg})∥* is the nuclear norm of the trajectory matrix data T(S_{reg}); and ∥E∥₁ is the L₁ norm of the erratic noise.

16. The non-transitory computer-readable medium of claim 9, wherein the generation of the noise reduced, interpolated frequency slice involves attenuation of both random noise and the erratic noise.

17. A computing system (200) for performing a method for enhancing desired data in seismic survey data captured from a surveyed area by simultaneously attenuating noise and interpolating the seismic data, the computing system comprising:
a storage device (208) comprising a plurality of overlapping subvolumes formed from the seismic survey data; and
a processor (204) in communication with the storage device (208) and configured to
select a frequency slice of one of the plurality of overlapping subvolumes formed from the seismic survey data (105, 310, 316);
generate a noise reduced, interpolated frequency slice by jointly minimizing a nuclear norm of trajectory matrix data corresponding to the desired data and an L₁ norm of erratic noise in the selected frequency slice (115, 320-326);
combine the noise reduced and interpolated frequency slice with at least one other frequency slice to produce a noise reduced, interpolated frequency subvolume of the surveyed area (130, 332); and
combine the noise reduced, interpolated frequency subvolume with at least one other noise reduced, interpolated frequency subvolume to produce noise reduced, interpolated seismic data of the surveyed area (338).

18. The computing system of claim 17, wherein the processor produces the noise reduced, interpolated frequency slice by iteratively processing the selected frequency slice.

19. The computing system of claim 17, wherein the selected frequency slice is noisy and incomplete spatially regularly sampled data, and the joint minimization recovers a low-rank signal model of the desired data and a sparse erratic noise model from the noisy and incomplete spatially regularly sampled data, and the joint minimization is
minimize ∥T(S)∥*+λ∥P[E]∥₁
subject to P[D]=S+E+Z,
∥Z∥₂≦δ.
where D is the selected frequency slice; S is noise reduced, interpolated frequency slice; E is the erratic noise data; Z is the additive random noise data; δ is an assumed level of random noise; λ is a regularization parameter; ∥T(S)∥* is the nuclear norm of the trajectory matrix data T(S) for the noise reduced, interpolated frequency slice S; ∥P[E]∥₁ is the L₁ norm; and P[•] is a sampling operator.

20. The computing system of claim 17, wherein the selected frequency slice is noisy and incomplete spatially irregularly sampled data, and the joint minimization recovers a low-rank signal model of the desired data and a sparse erratic noise model from the noisy and incomplete spatially irregularly sampled data the seismic data, and the joint minimization is
minimize ∥T(S_{reg})∥*+λ∥E∥₁
subject to D= [symbol] S_{reg}+E+Z,
∥Z∥₂≦δ
where [symbol] is a regular to irregular sampling operator, S_{reg} is the noise reduced, interpolated frequency slice, that is regularized on spatial domain grid [symbol] ; D is the selected frequency slice; E is the erratic noise; Z is additive random noise; δ is an assumed level of random noise; λ is a regularization parameter; is the nuclear norm of the trajectory matrix data T(S_{reg}); and ∥E∥₁ is the L₁ norm of the erratic noise.
